(19) United States
(12) Patent Application Publication
(10) Pub. No.: US 2025/0179755 A1
(43) Pub. Date: Jun. 5, 2025

(54) SOLAR TRACKER FOUNDATIONS

(71) Applicant: Nextracker LLC, Fremont, CA (US)

(72) Inventors: Abhimanyu Anil Sable, Hyderabad Telangana (IN); Raghavendra Praveen Maddulapalli, Hyderabad Telangana (IN); Jacob Mark Morin, Phoenix, AZ (US); Rajeev Kumar Samayamanthula, Andhra Pradesh (IN)

(21) Appl. No.: 18/796,571

(22) Filed: Aug. 7, 2024

Related U.S. Application Data
(63) Continuation-in-part of application No. 18/524,572, filed on Nov. 30, 2023.

(51) Int. Cl. E02D 27/42; F24S 25/617

(52) U.S. Cl. CPC E02D 27/42; F24S 25/617

(57) ABSTRACT

A solar module support and foundation system includes a first concrete foundation, a second concrete foundation, and a solar module A-frame support. The first concrete foundation is within a first bore and includes a first concrete foundation stem portion and a first concrete foundation reamed bulb portion. The second foundation is within a second bore and includes a second concrete foundation stem portion and a second concrete foundation reamed bulb portion. A first leg distal end of the A-frame support is nested within the first concrete foundation at each of the first concrete foundation stem and reamed bulb portions, and a second leg distal end of the A-frame support is nested within the second concrete foundation at each of the second concrete foundation stem and reamed bulb portions.

### PRIORITY CLAIM

This application is a continuation-in-part of, and claims priority to, U.S. patent application Ser. No. 18/524,572 which was filed on Nov. 30, 2023, the contents of which are hereby incorporated by reference.

### TECHNICAL FIELD

This disclosure relates generally to device, system, and method embodiments for solar tracker foundations. Certain such embodiments disclosed herein relate to concrete foundations for solar tracker supports.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules.

### SUMMARY

This disclosure in general describes embodiments of devices, systems, and methods relating to solar tracker foundations. Certain such embodiments disclosed herein relate to concrete foundations for solar tracker A-frame supports. Such embodiments disclosed herein can be configured to facilitate improved structural stability for solar tracking systems. In addition, embodiments disclosed herein can improve solar tracking system structural stability while increasing the efficiency of solar tracking foundation installation and reducing costs (e.g., foundation and/or support material costs) associated with solar tracker foundations and supports. As one example, certain embodiments disclosed herein may reduce solar module support material costs by up to 50% while yet at the same time provide increased structural stability for solar tracking systems by installing a more structurally robust foundation. Indeed, in some examples, certain solar module support features and certain foundation features can be synergistically complementary to achieve such benefits.

One embodiment includes a solar module support and foundation system. This system embodiment includes a first foundation, a second foundation, and a solar module A-frame support. The first foundation includes a first bore and a first concrete foundation. The first bore extends a depth below a ground surface, and the first concrete foundation is within the first bore. The first concrete foundation includes a first concrete foundation stem portion and a first concrete foundation reamed bulb portion. The first concrete foundation reamed bulb portion has a greater width than the first concrete foundation stem portion. The second foundation include a second bore and a second concrete foundation. The second bore extends a depth below the ground surface, and the second concrete foundation is within the second bore. The second concrete foundation includes a second concrete foundation stem portion and a second concrete foundation reamed bulb portion. The second concrete foundation reamed bulb portion has a greater width than the second concrete foundation stem portion. The solar module A-frame support includes a first leg and a second leg. The first leg has a first leg proximal end and a first leg distal end. The first leg distal end is nested within the first concrete foundation at each of the first concrete foundation stem portion and the first concrete foundation reamed bulb portion. The second leg has a second leg proximal end and a second leg distal end. The second leg distal end is nested within the second concrete foundation at each of the second concrete foundation stem portion and the second concrete foundation reamed bulb portion.

In a further embodiment of this system, the first concrete foundation reamed bulb portion can be embedded below the ground surface adjacent the ground surface and the first concrete foundation stem portion can be embedded below the ground surface below the first concrete foundation bulb portion. Likewise, the second concrete foundation reamed bulb portion can be embedded below the ground surface adjacent the ground surface and the second concrete foundation stem portion can be embedded below the ground surface below the second concrete foundation bulb portion. A width of the first concrete foundation bulb portion can be at least twice as large as a width of the first concrete foundation stem portion and/or a width of the second concrete foundation bulb portion can be at least twice as large as a width of the second concrete foundation stem portion.

In a further embodiment of this system, the first concrete foundation stem portion can be embedded below the ground surface adjacent the ground surface and the first concrete foundation bulb portion can be embedded below the ground surface below the first concrete foundation stem portion. Likewise, the second concrete foundation stem portion can be embedded below the ground surface adjacent the ground surface and the second concrete foundation bulb portion can be embedded below the ground surface below the second concrete foundation stem portion. In some such examples, the first concrete foundation stem portion can bound the first concrete foundation bulb portion such that the first concrete foundation stem portion is at each of opposite longitudinal end portions of the first concrete foundation and the first concrete foundation bulb portion is spaced apart from each of the opposite longitudinal end portions of the first concrete foundation. For instance, the first concrete foundation bulb portion can be spaced apart a different distance from each of the opposite longitudinal end portions of the first concrete foundation. In one such specific example, the first concrete foundation bulb portion can be spaced apart from a distal longitudinal end portion of the first concrete foundation a distance equal to at least half of a width of the first concrete foundation stem portion.

In a further embodiment of this system, the first concrete foundation reamed bulb portion can include a polygonal cross-sectional shape and/or the second concrete foundation reamed bulb portion can include a polygonal cross-sectional shape.

In a further embodiment of this system, a first radial surface at a first side of the polygonal cross-sectional shape of the first concrete foundation reamed bulb portion can include a first skewed surface relative to a central longitudinal axis of the first concrete foundation and/or a second radial surface at a second, opposite side of the polygonal cross-sectional shape of the first concrete foundation reamed bulb portion can include a second skewed surface relative to the central longitudinal axis of the first concrete foundation.

In a further embodiment of this system, the solar module A-frame support further includes a bracket that is above the ground surface and adjacent the first leg proximal end and the second leg proximal end.

In a further embodiment of this system, the first concrete foundation is a pre-cast concrete foundation. For example, each of the first concrete foundation and the second concrete foundation can be a pre-cast concrete foundation.

In a further embodiment of this system, the solar module A-frame support further includes a cross-brace extending between the first leg and the second leg above the ground surface.

In a further embodiment of this system, the first leg includes a polygonal cross-sectional shape, and/or the second leg includes a polygonal cross-sectional shape. As one example, the first leg can include a triangular cross-sectional shape and/or the second leg can include a triangular cross-sectional shape.

In a further embodiment of this system, the first leg proximal end is integral with the first leg distal end and/or the second leg proximal end is integral with the second leg distal end. The first leg distal end can be closed and/or the second leg distal end can be closed.

Another embodiment disclosed herein includes a method. This method embodiment includes steps of: placing a distal end of a first split tube subterranean leg within a first bore beneath a ground surface and placing cement within the first bore beneath the ground surface, where the first split tube subterranean leg is placed within the first bore such that a first frame connection member at a proximal end of the first split tube subterranean leg is above the ground surface; placing a distal end of a second split tube subterranean leg within a second bore beneath the ground surface and placing cement within the second bore beneath the ground surface, where the second split tube subterranean leg is placed within the second bore such that a second frame connection member at a proximal end of the second split tube subterranean leg is above the ground surface; coupling a first leg of a solar module A-frame support to the first frame connection member at the proximal end of the first split tube subterranean leg; and coupling a second leg of the solar module A-frame support to the second frame connection member at the proximal end of the second split tube subterranean leg.

In a further embodiment of this method, the cement can be placed within the first bore before the distal end of the first split tube subterranean leg is placed within the first bore, and the cement can be placed within the second bore before the distal end of the second split tube subterranean leg is placed within the first bore. The first split tube subterranean leg can include a split prong configuration that includes a first prong member extending around a first portion of a perimeter of the distal end of the split tube subterranean leg, a second prong member extending around a second portion of the perimeter of the distal end of the split tube subterranean leg, a first gap extending around the perimeter of the distal end of the split tube subterranean leg between the first prong member and the second prong member, and a second gap opposite the first gap and extending around the perimeter of the distal end of the split tube subterranean leg between the first prong member and the second prong member.

Another embodiment disclosed herein includes another method. This method embodiment includes steps of: placing a distal end of a first anchor member, a first reinforcement bar received at the distal end of the first anchor member, and a second reinforcement bar received at the distal end of the first anchor member within a first bore beneath a ground surface and placing cement within the first bore beneath the ground surface; placing a distal end of a second anchor member, a third reinforcement bar received at the distal end of the second anchor member, and a fourth reinforcement bar received at the distal end of the second anchor member within a second bore beneath the ground surface and placing cement within the first bore beneath the ground surface; coupling a first leg of a solar module A-frame support to a first frame connection member at a proximal end of the first anchor member that is above the ground surface; and coupling a second leg of the solar module A-frame support to a second frame connection member at a proximal end of the second anchor member that is above the ground surface.

An additional embodiment includes a method of installing a solar tracker concrete foundation. This method embodiment can include a step of creating a bore under a ground surface. This method can further include a step of placing each of a distal end of an anchor member (e.g., W-beam) and continuous reinforcement bar(s), received at the distal end of the anchor member, within the bore beneath ground surface. This step can also include placing cement within the bore beneath the ground surface before, after, or simultaneous to placing the distal end of the anchor member within the bore. This method can additionally include a step of coupling at least one solar tracker component (e.g., bearing housing assembly, drive mechanism, solar module) to a proximal end of the anchor member that is above the ground surface.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a side elevational view of an embodiment of a plurality of solar module support frames and associated foundations for use in a solar module tracking system. FIG. 1 shows the side elevational view looking in an east-west orientation.

FIG. 2 is a side elevational view of an embodiment of one solar module support frame and associated foundation of FIG. 1.

FIGS. 3A and 3B illustrate bracket embodiments for use with the solar module support frames of FIG. 1. FIG. 3A is a perspective view of one embodiment of a bracket, and FIG. 3B is a perspective view of another embodiment of a bracket.

FIG. 4 is a flow diagram of an embodiment of a method for installing a solar module support frame at a concrete foundation.

FIGS. 5A-5E illustrate an exemplary sequence for installing a solar module support frame at a concrete foundation, for instance, in accordance with some embodiments of the method of FIG. 4. FIG. 5A is a side elevational view of a first stage in the sequence, FIG. 5B is a side elevational view of a second stage in the sequence, FIG. 5C is a side elevational view of a third stage in the sequence, FIG. 5D is a side elevational view of a fourth stage in the sequence, and FIG. 5E is a side elevational view of a fifth stage in the sequence.

FIG. 6 is a side elevational view of another embodiment of a solar module support frame and associated foundation of FIG. 1, where a concrete foundation includes a stem portion and a bulb portion.

FIG. 7 is a side elevational view of another embodiment of a solar module support frame and associated foundation of FIG. 1, where a concrete foundation includes a stem portion and a bulb portion.

FIG. 8 is a side elevational view of an embodiment of a solar module support frame and associated foundation of FIG. 1, where a concrete foundation includes a pre-cast concrete foundation.

FIG. 9 is a side elevational view of an embodiment of a solar module support frame that includes a cross-brace.

FIGS. 10A and 10B illustrate one embodiment of a solar module support frame that includes a triangular leg cross-sectional shape. FIG. 10A shows a perspective view of the solar module support frame, and FIG. 10B shows a close-up perspective view of a portion of a leg of the solar module support frame including the triangular leg cross-sectional shape.

FIGS. 11A and 11B illustrate one embodiment of a solar module support frame that includes a polygonal leg cross-sectional shape. FIG. 11A shows a perspective view of the solar module support frame, and FIG. 11B shows a close-up perspective view of a portion of a leg of the solar module support frame including the polygonal leg cross-sectional shape.

FIGS. 12A and 12B illustrate an embodiment of a solar module support frame and associated foundation of FIG. 1, where the concrete foundation includes a split tube subterranean leg. FIG. 12A is an elevational view of the split tube subterranean leg at the concreate foundation, and FIG. 12B is an elevational view of the solar module support frame (e.g., A-frame) and associated concrete foundation with the split tube subterranean leg.

FIGS. 13A-13D illustrate embodiments of a reinforcement bar anchor for a concrete foundation. FIG. 13A is an exploded view of one embodiment of the reinforcement bar anchor, FIG. 13B is a perspective view of the embodiment of the reinforcement bar anchor at a concrete foundation, and FIG. 13C is an elevational view of a solar module support frame (e.g., A-frame) and associated concrete foundation with the embodiment of the reinforcement bar anchor. FIG. 13D is a perspective view of another embodiment of a reinforcement bar anchor for a concrete foundation.

FIGS. 14A and 14B illustrate another embodiment of a reinforcement bar anchor at a concrete foundation. FIG. 14A is a perspective view of the reinforcement bar anchor at the concrete foundation, and FIG. 14B is a side elevational view of the reinforcement bar anchor at the concrete foundation.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods relating to solar tracker foundations. Certain such embodiments disclosed herein relate to concrete foundations for solar tracker A-frame supports configured to facilitate improved structural stability for solar tracking systems. Certain such embodiments disclosed herein can improve solar tracking system structural stability while increasing the efficiency of solar tracking foundation installation and reducing costs (e.g., foundation and/or support material costs) associated with solar tracker foundations and supports.

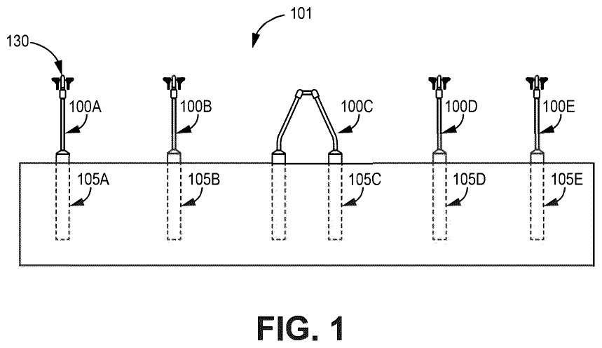

FIG. 1 is a is a side elevational view of an embodiment of a system 101 that includes a plurality of solar module support frames 100A, 100B, 100C, 100D, 100E and associated foundations 105A, 105B, 105C, 105D, 105E. FIG. 1 shows the system 100 at a side elevational view looking in an east-west orientation at the solar module support frames 100A-100E and respective, associated foundations 105A-105E. As illustrated, the solar module support frames 100A, 100B, 100D, 100E can be oriented in one direction, while the solar module support frame 100C can be oriented in a different direction, such as generally ninety degrees offset from the solar module support frames 100A, 100B, 100D, 100E. For instance, the solar module support frames 100A, 100B, 100D, 100E can face one of east-west and north-south while the solar module support frame 100C can face the other of east-west and north-south.

The system 101 that includes the solar module support frames 100A-100E and respective, associated foundations 105A-105E can be used to support a solar module tracking system. For example, the solar module support frames 100A-100E and respective, associated foundations 105A-105E can be used to support a solar module tracking system that includes one or more solar modules, one or more mounting assemblies, and a torque tube. Each of the one of more solar modules can include a frame and a plurality of photovoltaic cells that are configured to receive sunlight and as a result generate electrical energy. Each mounting assembly can connect at least one solar module to the torque tube, and the torque tube can be configured to rotatably move one or more such solar modules. The torque tube can be actuated by a controller to cause the torque tube to move, such as rotate about a longitudinal axis of the torque tube. As such, with one or more solar modules coupled to the torque tube via one or more mounting assemblies, as the torque tube is moved the one or more solar modules coupled to the torque tube are also moved. This can facilitate more optimized solar power generation at the photovoltaic cells by adjusting the angle of the one or more solar modules at one or more times (e.g., at times during a given day) to help “track” the sun as it moves over that period of time and, thereby, maintain more optimized positioning of the photovoltaic cells relative to the angle of sunlight irradiation at that given time of the day.

The solar module support frames 100A-100E and respective, associated foundations 105A-105E used to support a solar module tracking system can experience a variety of force loads. For example, the solar module support frames 100A-100E and respective, associated foundations 105A-105E can experience dynamic loads in the field from natural forces, such as wind loads. As another example, the solar module support frames 100A-100E and respective, associated foundations 105A-105E can experience dynamic loads in the field resulting from operation of the solar module tracking system, such as loads on the solar module support frames 100A-100E and respective, associated foundations 105A-105E resulting from movement (e.g., rotation) of the torque tube that can be supported at the solar module support frames 100A-100E. In some instances, these loads can occur at a same time, resulting in meaningful force loading at the solar module support frames 100A-100E. Accordingly, it can be useful to accommodate such loads experienced at the solar module support frames 100A-100E using a structurally robust foundation for the solar module support frames 100A-100E. Yet, because a typical solar module tracking system can include hundreds or thousands of solar module support frames 100A-100E each needing a dedicated foundation 105A-105E, material/cost and installation efficiency of the associated foundations 105A-105E can be useful.

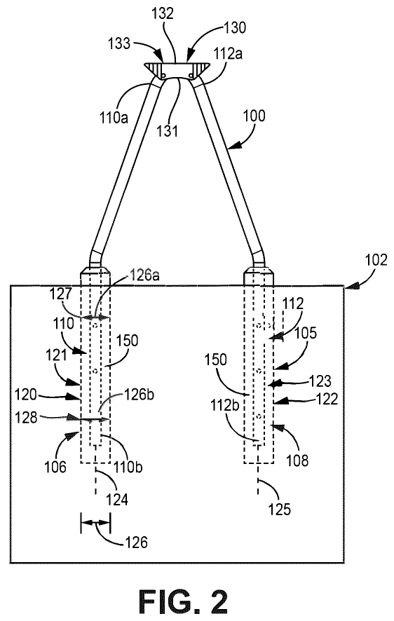

FIG. 2 is a side elevational view of an embodiment of one solar module support frame 100 and associated foundation 105. The solar module support frame 100 and associated foundation 105 can, in some applications, be part of the system 101 shown and described with respect to FIG. 1.

The illustrated embodiment of the foundation 105, associated with the solar module A-frame support 100, includes a first foundation 106 and a second foundation 108. The first foundation 106 can include a first bore 120 and a first concrete foundation 121. The first bore 120 can extend a depth below a ground surface 102, and the first concrete foundation 121 can be within (e.g., at least partially within) the first bore 120. The second foundation 108 can include a second bore 122 and a second concrete foundation 123. The second bore 122 can extend a depth below the ground surface 192, and the second concrete foundation 123 can be within (e.g., at least partially within) the second bore 122. In some examples, the first bore 120 and the second bore 122 can be created at a same time to extend into the ground surface 102 to a predetermined depth. The first concrete foundation 121 and the second concrete foundation 123 can each have a concrete volume equal to or less than 0.50 cubic meters, equal to or less than 0.25 cubic meters, equal to or less than 0.15 cubic meters, or equal to or less than 0.10 cubic meters. Such concrete volume for each concrete foundation 121, 123 can be a relatively little volume optimized for the solar tracking system loading expected to be experienced in the field and in view of the other components and characteristics of the foundation 105 such that a cost savings associated with concrete material needed across a solar tracking system application can be realized.

The first foundation 106 can be separate from the second foundation 108. For example, as illustrated at the example of FIG. 2, the first bore 120 can be a separate bore from the second bore 122 and, likewise, the first concrete foundation 121 can be a separate concrete foundation from the second concrete foundation 123. In such examples where the first foundation 106 is separate from the second foundation 108, the first foundation 106 can be separated from the second foundation 108 by a region therebetween that is generally at the elevation of the ground surface 102 without any bore at this region between the first and second foundations 106, 108.

The first and second bores 120, 122 can be created to extend below the ground surface 102 in a manner that can provide sufficient structural anchoring and stability to the respective first and second legs 110, 112 of the solar module support frame 100. As one example, the first and second bores 120, 122 can be created to extend below the ground surface 102 a depth greater than a length of the respective first and second legs 110, 112 to be nested within the respective bore 120, 122. As an additional example, a cross-sectional width 126 of the respective bore 120, 122 can be created to be larger than a width of the respective first and second legs 110, 112 to be nested within the respective bore 120, 122. In some embodiments, the cross-sectional width 126 of the respective bore 120, 122 can vary along a depth of the respective bore 120, 122. For instance, the first bore 120 can have a first bore first width 126a at a first depth 127 below the ground surface 102 and a first bore second width 126b a second depth 128 below the ground surface. In one such example, the second depth 128 can be further below the ground surface 102 than the first depth 127 and the first bore second bore width 126b can be greater than the first bore first width 126a. In such an example where the first and/or second bore 120, 122 includes a larger bore cross-sectional width at a relatively deeper location, this can help to provide additional anchoring stability to the respective leg 110, 112 that is be nested within the respective bore 120, 122.

The illustrated embodiment of the solar module support frame 100 is a solar module A-frame support 100. The solar module A-frame support 100 can include the first leg 110 and the second leg 112. The first leg 110 can be connected to the second leg 112, either integrally or via a connecting member, to form the A-frame support 100. The first leg 110 can include a first leg proximal end 110a and a first leg distal end 110b. The first leg distal end 110b can be nested within the first concrete foundation 121. In one example, such as that shown for the illustrated embodiment, the first leg 110 of the solar module A-frame support 100 can be nested within the first concrete foundation 121 so as to extend along a first axis 124 (e.g., a central longitudinal axis 124 defined by the first leg distal end 110b) that is perpendicular to the ground surface 102. The illustrated example shows the solar module A-frame support 100 having the first leg 110 with a first leg subterranean portion, beneath the ground surface 102 and within the bore 120, that includes the first leg distal end 110b and a linear first leg portion extending along the axis 124, while the first leg 110 has a first leg above ground portion that is skewed relative to the first leg subterranean portion and thus offset from the axis 124. The second leg 112 can include a second leg proximal end 112a and a second leg distal end 112b. The second leg distal end 112b can be nested within the second concrete foundation 123. In one example, such as that shown for the illustrated embodiment, the second leg 112 of the solar module A-frame support 100 can be nested within the second concrete foundation 123 so as to extend along a second axis 125 (e.g., a central longitudinal axis 125 defined by the second leg distal end 112b) that is perpendicular to the ground surface 102. The second axis 125 can be spaced along the ground surface 102 from the first axis 124, and, in some instances, the first and second axes can be parallel to one another. The illustrated example shows the solar module A-frame support 100 having the second leg 112 with a second leg subterranean portion, beneath the ground surface 102 and within the bore 122, that includes the second leg distal end 112b and a linear second leg portion extending along the axis 125, while the second leg 112 has a second leg above ground portion that is skewed relative to the second leg subterranean portion and thus offset from the axis 125.

The illustrated embodiment of the solar module A-frame support 100 has the first leg distal end 110b closed and the second leg distal end 112b closed. Closed distal ends 110b, 112b of the legs 110, 112 can be useful in reducing or preventing egress of matter into the interior of the legs 110, 112 (e.g., to help reduce of prevent egress of subterranean ground matter, such as rock and soil, and/or foundation material, such as cement/concrete).

The illustrated embodiment of the solar module A-frame support 100 includes the first leg 110 and the second leg 112 as integral legs. For example, the illustrated embodiment of the solar module A-frame support 100 includes the first leg proximal end 110a integral with the first leg distal end 110b and includes the second leg proximal end 112a integral with the second leg distal end 112b. Thus, the leg 110, 112 portion(s) above ground surface 102 and the leg 110, 112 portions below ground surface 102 (subterranean leg portion(s)) can be integral. In a further such example the solar module A-frame support 100 can include the first leg 110 integral with the second leg 112 such that the first leg proximal end 110a is integral with the second leg proximal end 112a, through in another example the first leg 110 and the second leg 112 can be separate members connected together by a connecting member (e.g., via a bracket 130).

The solar module A-frame support 100 can additionally include the bracket 130. The bracket 130 can be above the ground surface 102, and the bracket 130 can be adjacent to the first leg proximal end 110a and the second leg proximal end 112a. For example, the bracket 130 can be configured to support thereat one or more components of a solar module tracking system. As one particular such example, the bracket 130 can be configured to support a rotatable torque tube of the solar module tracking system. This could include, for instance, a bearing housing assembly support at the bracket 130, and the bearing housing assembly rotatably receiving the torque tube. The bracket 130 can include a first bracket side 131 that faces the first leg proximal end 110a and the second leg proximal end 112a and a second bracket side 132 that is opposite the first bracket side 131. The second bracket side 132 can include a support surface 133, and the support surface 133 can be configured to support one or more components of a solar module tracking system, such as a bearing housing assembly and a rotatable torque tube received at the bearing housing assembly.

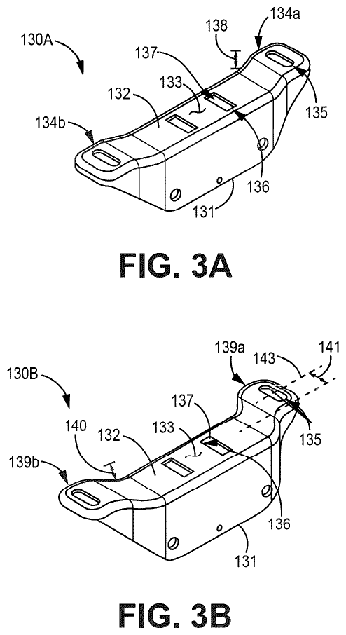

FIGS. 3A and 3B illustrate different embodiments of the bracket 130 for use with the solar module support frame 100.

FIG. 3A is a perspective view of one embodiment of a bracket 130A. The bracket 130A has the first bracket side 131 that faces the first leg proximal end and the second leg proximal end as well as the second bracket side 132 that is opposite the first bracket side 131. And the second bracket side 132 includes the support surface 133. The support surface 133 incudes at least one coupling aperture 136 defined thereat. The illustrated embodiment further incudes an interference member 137 at the coupling aperture 136 to help facilitate coupling the bracket 130A to a corresponding mounting assembly (e.g., for a bearing housing assembly). The support surface 133 includes a first support surface end portion 134a and a second support surface end portion 134b. Each of the first support surface end portion 134a and the second support surface end portion 134b includes a coupling aperture 135. Each of the first support surface end portion 134a and the second support surface end portion 134b defines an elevational offset 138 along the support surface 133. The elevational offset 138 can result in the support surface 133 at the first and second support surface end portions 134a, 134b being offset in elevation from a more central portion of the support surface 133. For example, the elevational offset 138 at the first and second support surface end portions 134a, 134b can be equal to or greater than 50 mm.

FIG. 3B is a perspective view of another embodiment of a bracket 130B. The bracket 130B can be similar to the bracket 130A but define a different elevational offset and/or a different radial offset. The bracket 130B has the first bracket side 131 that faces the first leg proximal end and the second leg proximal end as well as the second bracket side 132 that is opposite the first bracket side 131. And the second bracket side 132, at the bracket 130B, includes the support surface 133. The support surface 133 incudes at least one coupling aperture 136 defined thereat along with the interference member 137. The support surface 133 at the bracket 130B includes a first support surface end portion 139a and a second support surface end portion 139b. Each of the first support surface end portion 139a and the second support surface end portion 139b includes a coupling aperture 135. Each of the first support surface end portion 139a and the second support surface end portion 139b can define an elevational offset 140 along the support surface 133. The elevational offset 140 can result in the support surface 133 at the first and second support surface end portions 139a, 139b being offset in elevation from a more central portion of the support surface 133 at the bracket 130B. For example, the elevational offset 140 at the first and second support surface end portions 139a, 139b can be equal to or greater than 90 mm. The bracket 130B can, in addition to the elevational offset 140, in some embodiments include a radial offset 141. The illustrated embodiment of the bracket 130B includes the radial offset 141 that orients the first support surface end portion 139a offset from the second support surface end portion 139b. For example, the second support surface end portion 139b can be on the central radial axis 142 of the body of the bracket 130B, while the first support surface end portion 139a can be offset from the central radial axis 142 of the body of the bracket 130B. As shown, the first support surface end portion 139a can define a first support surface end portion radial axis 143 that is offset from the central radial axis 142 of the body of the bracket 130B by the distance of the radial offset 141.

In some embodiments of the system 101 shown at FIG. 1, the system 101 can include both the bracket 130A embodiment shown at FIG. 3A and the bracket 130B embodiment shown at FIG. 3B. For example, one or more of the solar module support frames 100A-100E can include the bracket 130A, while one or more others of the solar module support frames 100A-100E can include the bracket 130B. For instance, a majority of the solar module support frames 100A-100E can include the bracket 130A, while a minority of the solar module support frames 100A-100E can include the bracket 130B. The use of the bracket 130A at some of the solar module support frames 100A-100E and the use of the bracket 130B at others of the solar module support frames 100A-100E can be useful in providing greater installation tolerance when installing the solar module support frames 100A-100E and the bearing housing assembly and/or rotatable torque tube to be supported thereat. For instance, the greater tolerance provided by the variable elevation offset brackets 130A, 130B can be useful in installing the bearing housing assembly and/or rotatable torque in support at the solar module support frames 100A-100E given that the associated concrete foundations 105A-105E can generally be undesirable to reinstall in a manner to accommodate the installation of the bearing housing assembly and/or rotatable torque in support at the solar module support frames 100A-100E.

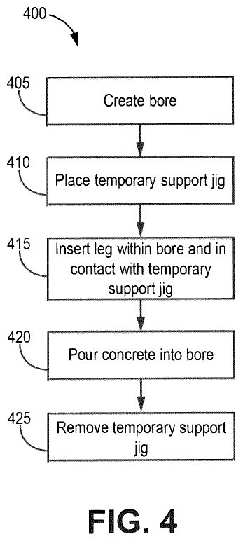

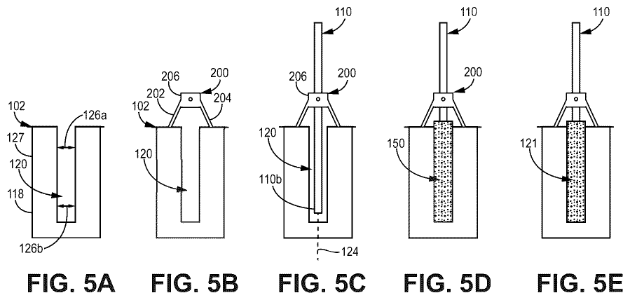

FIG. 4 is a flow diagram of an embodiment of a method 400 for installing a solar module support frame at a concrete foundation. For example, the method 400 can be executed to install the solar module A-frame support 100 and associated foundation 105, such as disclosed previously herein, for instance in reference to FIGS. 1 and 2. Thus, the method 400 can be executed to incorporate any one or more features disclosed previosuly herein with respect to the solar module A-frame supports and associated foundations. To help illustrate one exemplary application of the method 400, FIGS. 5A-5E will be referenced for illustrative purposes showing non-limiting examples of certain steps in the method 400. FIGS. 5A-5E illustrate an exemplary sequence for installing a solar module support frame at a concrete foundation, for instance, in accordance with some embodiments of the method 400. FIG. 5A is a side elevational view of a first stage in the sequence, FIG. 5B is a side elevational view of a second stage in the sequence, FIG. 5C is a side elevational view of a third stage in the sequence, FIG. 5D is a side elevational view of a fourth stage in the sequence, and FIG. 5E is a side elevational view of a fifth stage in the sequence.

At step 405, the method 400 includes creating bore 120 extending a depth below ground surface 102. As one example, the bore created to extend the depth below the ground surface 102 can have a volume equal to or less than 0.15 cubic meters (e.g., and a volume of the concrete poured into the bore, at step 420 can be equal to or less than 0.15 cubic meters). An another example, referring to FIG. 5A, the bore 120 can be created to extend the depth below the ground surface 102 such that a first portion of the bore at the first depth 127 below the ground surface 102 has a first bore width 126a and a second portion of the bore at a second depth 128, different than the first depth 127, below the ground surface 102 has a second bore width 126b. The first bore width 126a can be the same as or different than the second bore width 126b. As one example of creating the bore 120 at step 405, the second depth 128 can be further below the ground surface 102 than the first depth 127, and the second bore width 126b can be greater than the first bore width 126a.

Step 405 can include creating more than one bore. For example, step 405 can include creating the first bore 120 and the second bore 122 for a single A-frame support. In such an example, in some applications step 405 can be executed to create the first bore 120 and the second bore 122 simultaneously. Creating the first and second bores 120, 122 simultaneously can be helpful to minimize soil disturbance to the adjacent A-frame leg.

At step 410, the method 400 includes placing a temporary support jig 200 adjacent the bore 120 created at step 405. For applications of the method 400 where two bores are created (e.g., simultaneously) at step 405, step 410 can include placing a first temporary support jig adjacent the first bore 120 and a second temporary support jig adjacent the second bore 122.

Referring to the example shown at FIG. 5B, the temporary support jig 200 can be placed adjacent the bore 120 by placing the temporary support jig 200 at the ground surface 102 and above the bore 120 which extends a depth into the ground surface 102. The temporary support jig 200 can include a first jig leg 202 and a second jig leg 204. The first jig leg 202 can be placed at the ground surface 102 above the bore 120 at a first side of the bore 120 and the second jig leg 204 can be placed at the ground surface 102 above the bore 120 at a second side of the bore 120 different than the first side of the bore at which the first jig leg 202 is positioned. The temporary support jig 200 can further include a leg receiving opening 206 that is defined between the first jig leg 202 and the second jig leg 204. For example, as shown at the exemplary illustration at FIG. 5B, at step 410, the temporary support jig 200 can be placed at the ground surface 102 and above the bore 120 by placing the first jig leg 202 and the second jig leg 204 in contact with the ground surface 102 with the leg receiving opening 206, defined between the first and second jig legs 202, 204, positioned above the ground surface 102 and in axial alignment with the bore 120.

At step 415, the method 400 includes inserting a leg of a solar module A-frame support into the bore. For applications of the method 400 where two bores are created (e.g., simultaneously) at step 405, step 415 can include inserting a first leg of a solar module A-frame support into the first bore 120 and a second leg of the solar module A-frame support into the second bore 122.

Referring to the example shown at FIG. 5C, the leg 110 of the solar module A-frame support can be inserted into the bore 120 at step 415 such that a portion of the leg 110 of the solar module A-frame support contacts the temporary support jig 200. For example, the leg 110 of the solar module A-frame support can be inserted into the bore 120 at step 415 such that a portion of the leg 110 of the solar module A-frame support contacts the temporary support jig 200 at the leg receiving opening 206 between the first jig leg 202 and the second jig leg 204. For instance, the portion of the leg 110 of the solar module A-frame support placed into contact with the temporary support jig 200 can be a linear portion of the leg 110 that includes the leg distal end 110b and is to be at least partially embedded below the ground surface 102. At step 415, the 110 leg of the solar module A-frame support can be inserted into the bore 120 such that the portion of the leg 110 of the solar module A-frame support within the bore 120 extends within the bore 120 along axis 124 that is perpendicular to the ground surface 102. In some examples, the portion of the leg 110 of the solar module A-frame support within the bore 120 can be integral with the portion of the leg 110 of the solar module A-frame support that contacts the temporary support jig 200.

At step 420, the method 400 includes pouring concrete into the bore. For applications of the method 400 where two bores are created (e.g., simultaneously) at step 405, step 420 can include pouring concrete into each of the first and second bores 120, 122.

Referring to the example shown at FIG. 5D, concrete 150 can be poured into the bore 120 when the portion of the leg 110 of the solar module A-frame support is within the bore 120 and the portion of the leg 110 of the solar module A-frame support contacts the temporary support jig 200. Accordingly, the temporary support jig 200 can be useful in structurally supporting the leg 110 placed in the bore 102 while the foundation (e.g., concrete) cures. At step 420, the volume of concrete poured into each bore can be equal to or less than 0.50 cubic meters, equal to or less than 0.25 cubic meters, equal to or less than 0.15 cubic meters, or equal to or less than 0.10 cubic meters.

At step 425, the method 400 includes removing the temporary support jig. For applications of the method 400 where two bores are created (e.g., simultaneously) at step 405, step 425 can include removing each of the temporary support jigs positioned adjacent each of the bores.

Referring to the example shown at FIG. 5E, at step 425, after pouring concrete into the bore, the temporary support jig 200 can be removed from contact with the leg 110 of the solar module A-frame support. For example, the temporary support jig 200 can be removed from contact with the leg 110 of the solar module A-frame support after the concrete poured into the bore 120 has cured. As one particular such example, at step 425, once the concrete poured into the bore 120 has cured to form the concrete foundation 121, the temporary support jig 200 can be removed from contact with the leg 110.

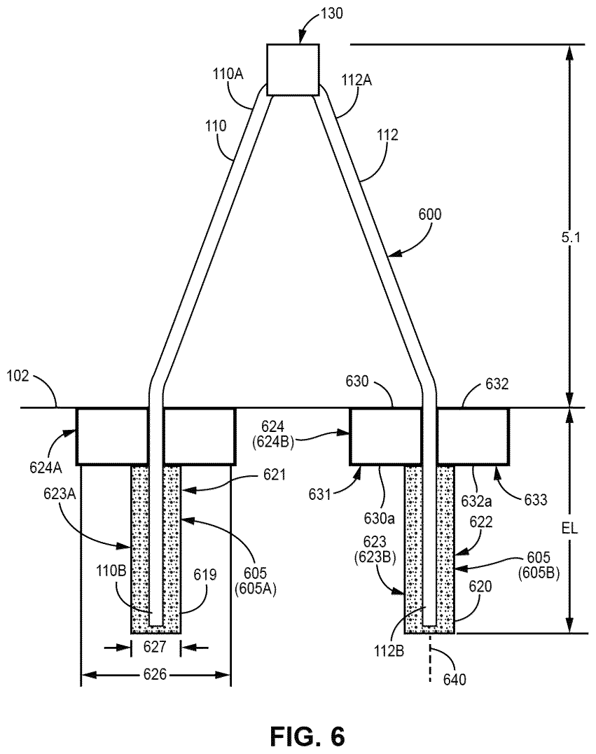

The following will describe additional exemplary embodiments of solar module foundations and solar module A-frame supports. For various applications, one or more (e.g., each) of the features disclosed as follows and/or at FIGS. 6-13C can be used with any one or more of the features disclosed previosuly herein and/or at FIGS. 1-5. As one such example, any one or more (e.g., each) of the features disclosed as follows and/or at FIGS. 6-13C can be used with any one or more of the features disclosed previosuly herein and/or at FIGS. 1-5 with respect to creating a concrete foundation (e.g., using a temporary support jig).

FIG. 6 is a side elevational view of another embodiment of a solar module support frame 600 and associated foundation 605 of FIG. 1. For some embodiments, the solar module support frame 600 can be similar to, or the same as, the solar module support frame embodiments (e.g., solar module support frame 100) disclosed elsewhere herein except as otherwise disclosed as follows. For example, the solar module support frame 600 includes concrete foundations 621, 622, and, for some embodiments, concrete foundation 621 can be similar to, or the same as, the concrete foundation embodiments (e.g., concrete foundation 121, 122) disclosed elsewhere herein except that concrete foundations 621, 622 can have a different geometric configuration. Namely, that each of the concreate foundations 621, 622 can include a stem portion 623 and a reamed bulb portion 624.

The illustrated example of the foundation 605 includes a first foundation 605A and a second foundation 605B. The first foundation 605A can include a first bore 619 extending a depth below ground surface 102, and the first foundation 605A can include first concrete foundation 621 within the first bore 619. The first concrete foundation 621 can include a first concrete foundation stem portion 623A and a first concrete foundation reamed bulb portion 624A. The first concrete foundation reamed bulb portion 624A can have a greater width than the first concrete foundation stem portion 623A. Similarly, the second foundation 605B can include a second bore 620 extending a depth below ground surface 102, and the second foundation 605B can include second concrete foundation 622 within the second bore 620. The second concrete foundation 622 can include a second concrete foundation stem portion 623B and a second concrete foundation reamed bulb portion 624B. The second concrete foundation reamed bulb portion 624B can have a greater width than the second concrete foundation stem portion 623B.

The solar module support frame 600 illustrated here is an A-frame support. This solar module A-frame support 600 can include first leg 110 and second leg 112. The first leg 110 can have the first leg proximal end 110a and the first leg distal end 110B. The first leg distal end 110B can be nested within the first concrete foundation 621 at each of the first concrete foundation stem portion 623A and the first concrete foundation reamed bulb portion 624A. Similarly, the second leg 112 can have the second leg proximal end 112A and the second leg distal end 112B. The second leg distal end 112B can be nested within the second concrete foundation 622 at each of the second concrete foundation stem portion 623B and the second concrete foundation reamed bulb portion 624B.

The embodiment shown here at FIG. 6 orients the first and second concrete foundations 621, 622 such that the respective bulb portions 624A, 624B are adjacent to, or at, ground surface 102 and the respective stem portions 623A, 623B are below the respective bulb portions 624A, 624B within the ground and respective bores 619, 620. Namely, as shown here, the first concrete foundation reamed bulb portion 624A is embedded below the ground surface 102 at or adjacent to the ground surface 102, and the first concrete foundation stem portion 623A is embedded below the ground surface 102 below the first concrete foundation bulb portion 624A. Similarly, as also shown here, the second concrete foundation reamed bulb portion 624B is embedded below the ground surface 102 at or adjacent to the ground surface 102, and the second concrete foundation stem portion 623B is embedded below the ground surface 102 below the second concrete foundation bulb portion 624B. The first and second concrete foundations 621, 622 can be embedded under the ground surface 102 an embedment length EL, which is some applications can be equal to the length of the respective bulb portion 624A, 624B of the respective concrete foundation 621, 622 plus the length of the respective stem portion 623A, 623B of the respective concrete foundation 621, 622.

The first concrete foundation reamed bulb portion 624A can have a greater width than the first concrete foundation stem portion 623A, and the second concrete foundation reamed bulb portion 624B can have a greater width than the second concrete foundation stem portion 623B. Namely, each of the first and second concrete foundation reamed bulb portion 624A, 624B can can define reamed bulb portion width 626, and each of the first and second concrete foundation stem portions 623A, 623B can define stem portion width 627. The reamed bulb portion width 626 can be greater than the stem portion width 627. For example, the reamed bulb portion width 626 can be at least twice as large as the stem portion width 627, the reamed bulb portion width 626 can be at least 2.5 times as large as the stem portion width 627, or the reamed bulb portion width 626 can be at least three times as large as the stem portion width 627. As one specific example for one exemplary application, the stem portion width 627 can be approximately 200 mm, and the reamed bulb portion width 626 can be at least 400 mm, at least 500 mm, or at least 600 mm.

For some embodiments, such as that shown here, each of the first concrete foundation reamed bulb portion 624A and the second concrete foundation reamed bulb portion 624B can include a polygonal cross-sectional shape. For example, each of the first concrete foundation reamed bulb portion 624A and the second concrete foundation reamed bulb portion 624B can include a first radial surface 630 at a first side 631 of the polygonal cross-sectional shape and a second radial surface 632 at a second, opposite side 633 of the polygonal cross-sectional shape of each such reamed bulb portion 624A, 624B. The first radial surface 630, at first side 631 of each of the reamed bulb portions 624A, 624B, can be a normal (perpendicular), linear surface relative to a central longitudinal axis 640 of the respective concrete foundation 621, 622 (e.g., the first normal, linear surface 630 can extend out from the central longitudinal axis 640 at an angle of ninety degrees relative to the central longitudinal axis 640). And, likewise, the second radial surface 632, at second side 633 of each of the reamed bulb portions 624A, 624B, can be a second normal (perpendicular), linear surface relative to the central longitudinal axis 640 of the respective concrete foundation 621, 622 (e.g., the second normal, linear surface 632 can extend out from the central longitudinal axis 640 at an angle of ninety degrees relative to the central longitudinal axis 640). As also shown for the illustrated embodiment, each of the reamed bulb portions 624A, 624B can include at the first side 631 another lower normal (perpendicular), linear radial surface 630a symmetrical to (e.g., parallel to) the radial surface 630 at the first side 631 and at the second side 633 another, lower normal (perpendicular), linear radial surface 632a symmetrical to (e.g., parallel to) the radial surface 632.

Also shown at the example of FIG. 6, the solar module A-frame support 600 can additionally include the bracket 130. As disclosed elsewhere herein, the bracket 130 can be above the ground surface 102 and adjacent the first leg proximal end 10A and the second leg proximal end 112A. In addition to or alternative to bracket 130, the solar module A-frame support 600 can include a bearing housing assembly above the ground surface 102 and adjacent the first leg proximal end 10A and the second leg proximal end 112A

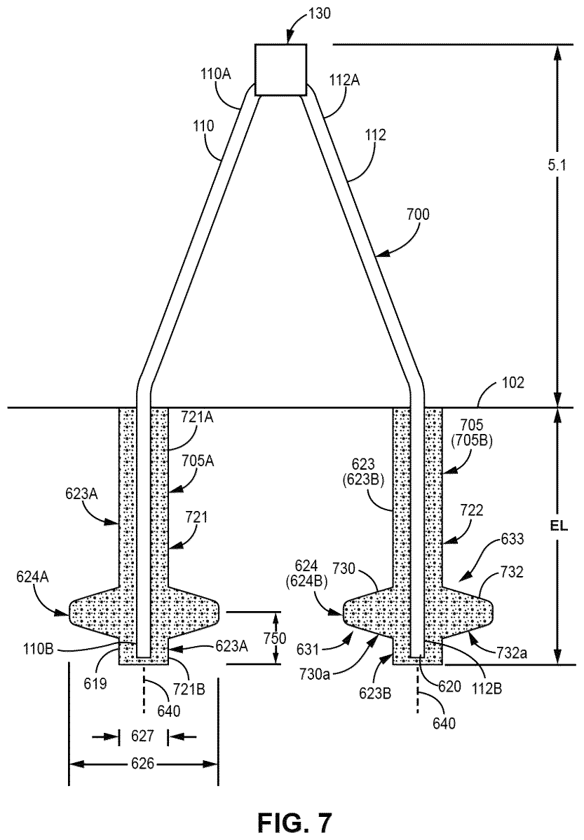

FIG. 7 is a side elevational view of another embodiment of a solar module support frame 700 and associated foundation 705 of FIG. 1. For some applications, the embodiment shown at FIG. 7 can be similar to that disclosed previosuly herein with respect to FIG. 6 except as otherwise disclosed as follows. In particular, the foundation 705 shown at the embodiment of FIG. 7 includes the stem portion 623 and the reamed bulb portion 624 like that at FIG. 6 except that the orientation of the stem portion 623 and the reamed bulb portion 624, relative to ground surface 102, are reversed as compared to that for the example at FIG. 6 and the geometry of one or more surfaces at each reamed bulb portion 624 is modified, as compared to FIG. 6, to include skewed radial surfaces relative to the concreate foundation central longitudinal axis instead of normal (perpendicular) radial surfaces as in the example at FIG. 6. Namely, the foundation 705 shown at the embodiment of FIG. 7 can have the stem portion 623 embedded below the ground surface 102 at or adjacent to the ground surface 102 while the reamed bulb portion 624 is embedded below the ground surface 102 below the stem portion 623.

The illustrated example of the foundation 705 includes first foundation 705A and a second foundation 705B. The first foundation 705A can include first bore 619 extending a depth below ground surface 102, and the first foundation 705A can include first concrete foundation 721 within the first bore 619. The first concrete foundation 721 can include first concrete foundation stem portion 623A and first concrete foundation reamed bulb portion 624A. The first concrete foundation reamed bulb portion 624A can have a greater width than the first concrete foundation stem portion 623A. Similarly, the second foundation 705B can include second bore 620 extending a depth below ground surface 102, and the second foundation 705B can include second concrete foundation 622 within the second bore 620. The second concrete foundation 622 can include second concrete foundation stem portion 623B and second concrete foundation reamed bulb portion 624B. The second concrete foundation reamed bulb portion 624B can have a greater width than the second concrete foundation stem portion 623B.

As noted, the embodiment shown here at FIG. 7 orients the first and second concrete foundations 721, 722 such that the respective stem portions 623A, 623B are adjacent to, or at, ground surface 102 and the respective reamed bulb portions 624A, 624B are below the respective stem portions 623A, 623B within the ground. Namely, as shown here, the first concrete foundation stem portion 623A is embedded below the ground surface 102 at or adjacent to the ground surface 102, and the first concrete foundation reamed bulb portion 624A is embedded below the ground surface 102 below the first concrete foundation stem portion 623A. Similarly, as also shown here, the second concrete foundation stem portion 623B is embedded below the ground surface 102 at or adjacent to the ground surface 102, and the second concrete foundation reamed bulb portion 624B is embedded below the ground surface 102 below the second concrete foundation stem portion 623B.

As shown for the embodiment at FIG. 7, the first concrete foundation stem portion 623A can bound the first concrete foundation bulb portion 624A such that the first concrete foundation stem portion 623A is at each of opposite longitudinal end portions 721A, 721B of the first concrete foundation 721 and the first concrete foundation bulb portion 624A is spaced apart from each of the opposite longitudinal end portions 721A, 721B of the first concrete foundation 721. In one such example, the first concrete foundation reamed bulb portion 624A can be spaced apart a different distance from each of the opposite longitudinal end portions 721A, 721B of the first concrete foundation 721. The illustrated embodiment at FIG. 7 shows the reamed bulb portion 624A closer to the bottom stem portion 623A at the bottom end portion 721B than to the top stem portion 623A at the top end portion 721A. For instance, the first concrete foundation bulb portion 624A can be spaced apart from bottom, distal longitudinal end portion 721B of the first concrete foundation 721 a distance 750 equal to at least half of width 626 of the first concrete foundation stem portion 624A, such as distance 750 ranging from half of width 626 to twice that of width 626. The second concrete foundation stem portion 623B can bound the second concrete foundation bulb portion 624B similar to that described here for the first concrete foundation stem portion 623A bounding the first concrete foundation bulb portion 624A.

As noted previously, each of the first concrete foundation reamed bulb portion 624A and the second concrete foundation reamed bulb portion 624B can include a polygonal cross-sectional shape. For example, for the illustrated embodiment shown here at FIG. 7, each of the first concrete foundation reamed bulb portion 624A and the second concrete foundation reamed bulb portion 624B can include a first radial surface 730 at a first side 631 of the polygonal cross-sectional shape and a second radial surface 732 at a second, opposite side 633 of the polygonal cross-sectional shape of each such reamed bulb portion 624A, 624B. The first radial surface 730, at first side 631 of each of the reamed bulb portions 624A, 624B, can be a skewed (e.g., and planar) surface relative to a central longitudinal axis 640 of the respective concrete foundation 621, 622 (e.g., the first skewed radial surface 730 can extend out from the central longitudinal axis 640 at an angle between zero and ninety degrees relative to the central longitudinal axis 640, such as an angle between thirty and sixty degrees). And, likewise, the second radial surface 732, at second side 633 of each of the reamed bulb portions 624A, 624B, can be a skewed (e.g., and planar) surface relative to the central longitudinal axis 640 of the respective concrete foundation 621, 622 (e.g., the second skewed radial surface 732 can extend out from the central longitudinal axis 640 at an angle between zero and ninety degrees relative to the central longitudinal axis 640, such as an angle between thirty and sixty degrees). As also shown for the illustrated embodiment, each of the reamed bulb portions 624A, 624B can include at the first side 631 another lower skewed radial surface 730a that can be the inverse skewed angular orientation of the skewed radial surface 730 at the same side 631, and each of the reamed bulb portions 624A, 624B can include at the second side 633 another lower skewed radial surface 732a that can be the inverse skewed angular orientation of the skewed radial surface 732 at the same side 633.

The inclusion of the noted stem and reamed bulb portions at a concrete foundation supporting an A-frame can be useful in increasing the lateral stability for the solar tracker via the concrete foundation. For example, the inclusion of the noted stem and reamed bulb portions at a concrete foundation supporting an A-frame can increase the lateral loading capacity associated with the concrete foundation by distributing lateral forces imparted at the solar tracker (e.g., wind loads) across the relatively, laterally elongated reamed bulb portion embedded below the ground surface.

The following embodiments will disclose features that can be used, for example, with any one or more of the concrete foundation and A-frame support features disclosed elsewhere herein.

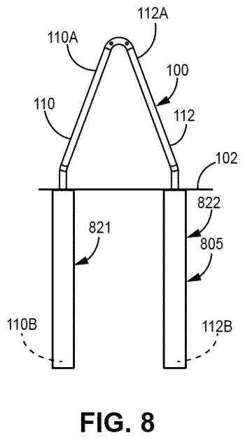

FIG. 8 is a side elevational view of an embodiment of solar module support frame 100 and associated concrete foundation 805 of FIG. 1, where concrete foundation 805 is a pre-cast concrete foundation. For example, the concrete foundation 805 can include a first pre-cast concrete foundation 821 and a second pre-cast concrete foundation 822. First leg 110 of the solar module A-frame support 100 can be at the first pre-cast concrete foundation 821, and the second leg 112 of the solar module A-frame support 100 can be at the second pre-cast concrete foundation 822. Namely, the first leg distal end 110B can be nested within the first pre-cast concrete foundation 821 before the first pre-cast concrete foundation 821 is embedded below ground surface 102, and the second leg distal end 112B can be nested within the second pre-cast concrete foundation 822 before the second pre-cast concrete foundation 822 is embedded below ground surface 102. The use of such pre-cast concrete foundations 821, 822 can be useful for solar tracker applications at terrains and/or soils for which post-bore creation concrete pouring and curing is a challenge.

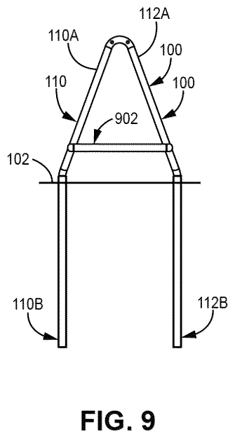

FIG. 9 is a side elevational view of an embodiment of a solar module support frame 900 that includes a cross-brace 902. The cross-brace 902 can define any or a variety or cross-sectional geometries. The solar module support frame 900 can be an A-frame support that includes first leg 110 and second leg 112. The cross-brace 902 can extend between the first leg 110 and the second leg 112. As shown here, the cross-brace 902 can extend between the first leg 110 and the second leg 112 above the ground surface 102. In particular, one end portion of the cross-brace 902 can be at the first leg 110 at a location thereat above the ground surface 102 and spaced apart from each of the first leg proximal end 110A and the first leg distal end 110B, and another, opposite end portion of the cross-brace 902 can be at the second leg 112 at a location thereat above the ground surface 102 and spaced apart from each of the second leg proximal end 112A and the second leg distal end 112B. The cross-brace 902 can extend generally parallel to ground surface 102 between the first and second legs 110, 112. The cross-brace 902 can form a type of truss at the A-frame support 100 and, as such, can help to increase the load bearing capacity associated with the solar module support frame 900.

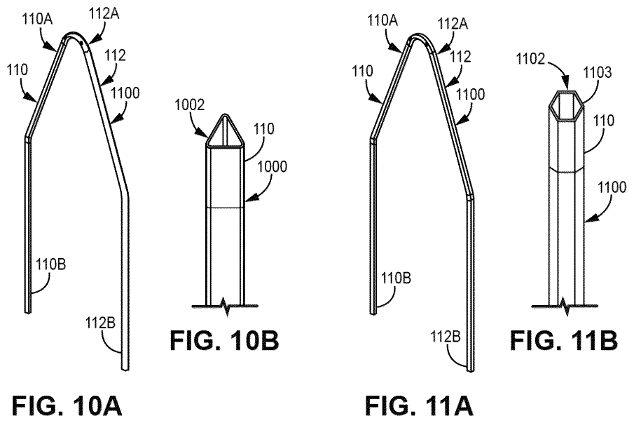

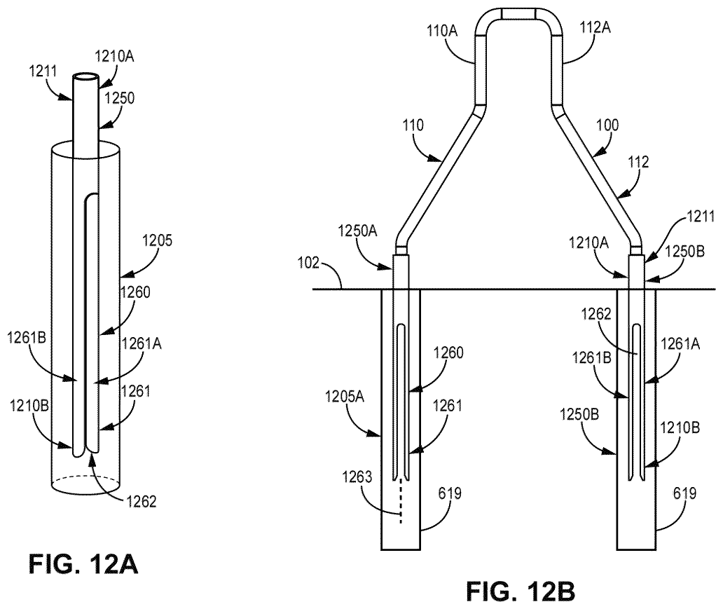

FIGS. 10-11 illustrate examples of solar module support frame features that can be used with any one or more other solar module support frame and/or concrete foundation features disclosed elsewhere herein.

FIGS. 10A and 10B illustrate one embodiment of a solar module support frame 1000 that includes a triangular leg cross-sectional shape 1002 at one or more portions of the solar module support frame 1000. FIG. 10A shows a perspective view of the solar module support frame 1000, and FIG. 10B shows a close-up perspective view of a portion of a leg 110 and/or 112 of the solar module support frame 1000 including the triangular leg cross-sectional shape 1002. For example, the first leg 110 and/or the second leg 112 can include the triangular leg cross-sectional shape 1002 (e.g., each first leg 110 and second leg 112 include the triangular leg cross-sectional shape 1002). In one more specific such example, all of the first leg 110 from and including the first leg proximal end portion 110A to and including the first leg distal end portion 110B can have the triangular leg cross-sectional shape 1002, and all of the second leg 112 from and including the second leg proximal end portion 112A to and including the second leg distal end portion 112B can have the triangular leg cross-sectional shape 1002. In other embodiments, the solar module support frame 1000 can additionally or alternatively include other types of polygonal cross-sectional shapes or a circular cross-sectional shape.

FIGS. 11A and 11B illustrate one embodiment of a solar module support frame 1100 that includes a polygonal leg cross-sectional shape 1102 at one or more portions of the solar module support frame 1100. FIG. 11A shows a perspective view of the solar module support frame 1100, and FIG. 11B shows a close-up perspective view of a portion of a leg 110 and/or 112 of the solar module support frame 1100 including the polygonal leg cross-sectional shape 1102. For example, the first leg 110 and/or the second leg 112 can include the polygonal leg cross-sectional shape 1102 (e.g., each first leg 110 and second leg 112 include the polygonal leg cross-sectional shape 1102). In one more specific such example, all of the first leg 110 from and including the first leg proximal end portion 110A to and including the first leg distal end portion 110B can have the polygonal leg cross-sectional shape 1102, and all of the second leg 112 from and including the second leg proximal end portion 112A to and including the second leg distal end portion 112B can have the polygonal leg cross-sectional shape 1102. The illustrated embodiment shows the polygonal leg cross-sectional shape 1102 as a hexagon formed by six sidewalls 1103 around a perimeter of the leg 110 and/or 112. Other embodiments the solar module support frame 1000 can additionally or alternatively include other types of polygonal cross-sectional shapes having less than six sidewalls 1103 or more than six sidewalls 1103.

The inclusion of a polygonal leg cross-sectional shape at one or more legs of a solar module A-frame support can help to increase the structural stability associated with the A-frame support by increasing resistance to lateral loads and/or rotational loads via the multi-side walled structure that can provide increased loading stability in multiple planes. For example, one sidewall at such a polygonal leg cross-sectional shape at one or more legs of a solar module A-frame support can be configured to resist lateral loads transferred to the one or more legs while another, different sidewall at such a polygonal leg cross-sectional shape at one or more legs of a solar module A-frame support can be configured to resist a different, non-lateral load (e.g., configured to resist a rotational load) transferred to the one or more legs.

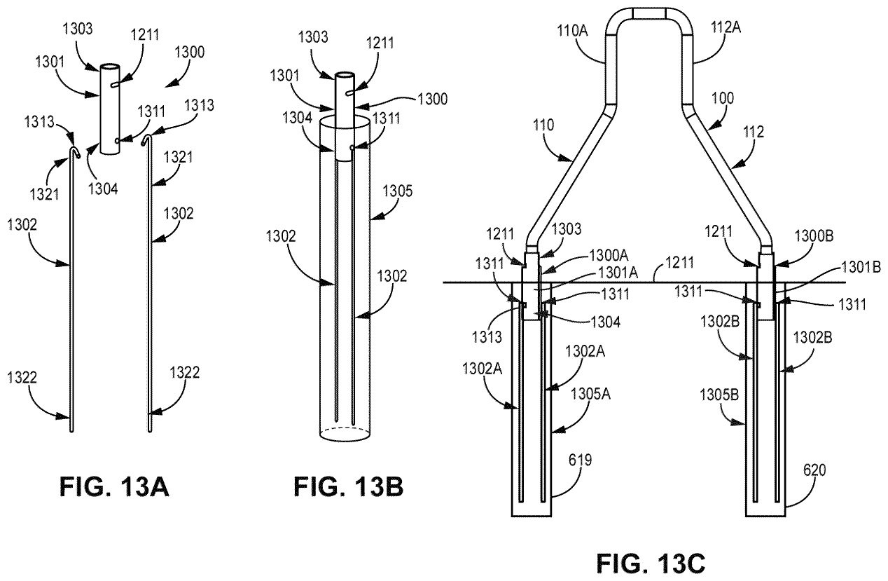

FIGS. 12A and 12B illustrate an embodiment of a solar module support frame 100 and associated foundation 1205 of FIG. 1, where the concreate foundation 1205 includes one or more split tube subterranean leg(s) 1250. FIG. 12A is an elevational view of the split tube subterranean leg 1250 at the concreate foundation 1205, and FIG. 12B is an elevational view of the solar module support frame 100 and associated first and second concrete foundation 1205A, 1205B each with a split tube subterranean leg 1250A, 1250B. Namely, as shown for the illustrated example, first concrete foundation 1205A can include first split tube subterranean leg 1250A and second concrete foundation 1205B can include second split tube subterranean leg 1250B.

The split tube subterranean leg 1250 can include leg proximal end 1210A and leg distal end 1210B that is opposite leg proximal end 1210A. Leg proximal end 1210A can include frame connection member 1211 that can be configured to couple to the solar module support frame 100. For example, referring to FIG. 12B, each of the first split tube subterranean leg 1250A and the second split tube subterranean leg 1250B can include the frame connection member at the leg proximal end 1210A such that the first split tube subterranean leg 1250A is configured to couple to the first leg 110 of the frame 100 at the frame connection member 1211 and the second split tube subterranean leg 1250B is configured to couple to the second leg 112 of the frame 100 at the frame connection member 1211. As shown for the illustrated example at FIG. 12B, when the split tube subterranean leg 1250 is embedded in the ground, the leg proximal end 1210A can remain above the ground surface 102 to provide connection axis to the frame connection member 1211 so that the frame legs 110, 112 can be coupled to respectively, the ground embedded first and second split tube subterranean legs 1250A, 1250B.

The leg distal end 1210B of the split tube subterranean leg 1250 can be embedded below ground surface 102 and nested within concrete foundation 1205 below ground surface 102. The leg distal end 1210B of the split tube subterranean leg 1250 can include a split prong configuration 1260. The split prong configuration 1260 can be at the leg distal end 1210B of each split tube subterranean leg 1250A, 1250B.

The split prong configuration 1260 at the split tube subterranean leg 1250 can include two or more prong members 1261 spaced apart from one another about the distal end 1210B of the split tube subterranean leg 1250. The illustrated embodiment shows two prong members—first prong member 1261A and second prong member 1261B—forming the split prong configuration 1260 at the distal end 1210B of the split tube subterranean leg 1250. More specifically, the first prong member 1261A is spaced apart from and separated from the second prong member about the distal end 1210B of the split tube subterranean leg 1250. For example, the first prong member 1261A can be spaced apart, and separated, from the second prong member 1261B by a gap 1262 at the distal end 1210B of the split tube subterranean leg 1250. For such an example, the first prong member 1261A can extend around a first portion of the distal end 1210B perimeter of the split tube subterranean leg 1250, the second prong member 1261B can extend around a second portion of distal end 1210B perimeter of the split tube subterranean leg 1250, a first gap 1262 can extend around the distal end 1210B perimeter of the split tube subterranean leg 1250 between the first and second prong members 1261A, 1261B, and a second gap 1262 can extend around the distal end 1210B perimeter of the split tube subterranean leg 1250 between the first and second prong members 1261A, 1261B. For instance, the first prong member 1261A can be generally opposite the second prong member 1261B about a central longitudinal axis 1263 of the split tube subterranean leg 1250 and adjacent to each of the first and second gaps 1262, and the first gap can be generally opposite the second gap about the central longitudinal axis 1263 of the split tube subterranean leg 1250 and adjacent to each of the first and second prong members 1261A, 1261B. Other embodiments within the scope of the present disclosure can include other numbers of prong members 1261, such as three or four prong members 1261, at the distal end 1210B of the split tube subterranean leg 1250.

A method of installing a concrete foundation can be executed to embed the concrete foundation 1205 in the ground with the split tube subterranean leg 1250. As one such embodiment, a first step can include creating a bore 619 under the ground surface 102 and/or creating a second bore 620 under the ground surface 102 and spaced apart along the ground surface 102 from the first bore 619. Then, as a next step, distal end 1210B of the split tube subterranean leg 1250 can be placed within the bore 619, such that the split prong configuration 1260 of the split tube subterranean leg 1250 is within the bore 619, and cement can be introduced into the bore 619. In one example, the split prong configuration 1260 of the split tube subterranean leg 1250 is placed within the bore 619 before introducing the cement into the bore 619, but in another example the cement is introduced into the bore first and then the split prong configuration 1260 of the split tube subterranean leg 1250 is placed within the bore 619 and within the cement within the bore 619. Then, as a next step, after the cement and split prong configuration 1260 have been placed within the bore 619, the frame 100 can be coupled to the split tube subterranean leg 1250. Namely, while the split prong configuration 1260 is within the bore 619, one frame leg 110 or 112 can be coupled to the frame connection member 1211 at the proximal end 1210A of the split tube subterranean leg 1250. This process can be repeated for a second bore 620 and a second split tube subterranean leg 1250B to ultimately, after the cement and split prong configuration 1260 have been placed within the second bore 620, the other frame leg 112 can be coupled to the second split tube subterranean leg 1250B.

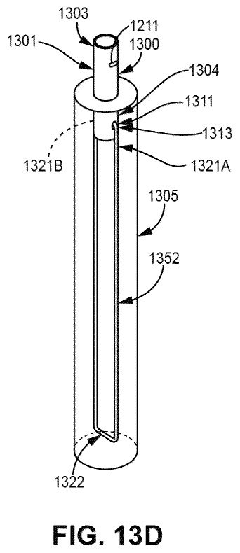

FIGS. 13A-13D illustrate embodiments of a reinforcement bar anchor 1300 for a concrete foundation. FIG. 13A is an exploded view of the reinforcement bar anchor 1300, FIG. 13B is a perspective view of the reinforcement bar anchor 1300 at a concrete foundation, and FIG. 13C is an elevational view of a solar module support frame (e.g., A-frame) and associated first concrete foundation 1305A with first reinforcement bar anchor 1300A and associated second concrete foundation 1305B with second reinforcement bar anchor 1300B. FIG. 13D is a perspective view of the reinforcement bar anchor 1300 for a concrete foundation but in this example the reinforcement bar anchor 1300 includes a continuous reinforcement bar 1352 at concrete foundation 1305.

The reinforcement bar anchor 1300 can include anchor member 1301 and one or more reinforcement bars 1302. The illustrated embodiment shows that the reinforcement bar anchor 1300 can include two reinforcement bars 1302, though for other embodiments within the scope of this disclosure the reinforcement bar anchor 1300 can include other numbers of reinforcement bars, such as one reinforcement bar 1302 or more than two reinforcement bars 1302. And the illustrated embodiment shows that the reinforcement bar anchor 1300 includes the two reinforcement bars 1302 that each are single strand members terminating at distal ends 1322 opposite the anchor member 1301 spaced apart from one another, though other embodiments within the scope of this disclosure can include one or more reinforcement bars 1302 that are each formed from two or more stand members and/or are continuous as such one or more reinforcement bars 1302 extend within the concrete foundation 1305 from one side of the anchor member 1301 to another side of the anchor member 1301.

The anchor member 1301 can be configured to receive the reinforcement bar(s) 1302 to assemble the reinforcement bar anchor 1300. The anchor member 1301 is illustrated for the exemplary embodiment here as a generally cylindrical hollow section, though in other embodiments the anchor member 1301 can have other cross-sectional geometries such as a generally rectangular hollow section, square hollow section, W-beam section, C-beam section, or I-beam section as examples. For some applications, the anchor member 1301 can serve as a foundation support pile embedded at least partially within the ground surface 102. In some such exemplary applications involving multi-leg solar module support frames (e.g., A-frame), the anchor member 1301 at first concrete foundation 1305A can serve as a first foundation support pile for a first support frame leg and another anchor member 1301 at another, second concrete foundation 1305B can serve as a second foundation support pile for a second support frame leg. In other such exemplary applications involving single-leg solar module support frames (e.g., W-beam, C-beam, I-beam), the anchor member 1301 at concrete foundation 1305 can serve as the foundation support pile for the single-leg solar module support frame and, thus, the anchor member 1301 can define a cross-sectional geometry as desired for such a single-leg solar module support frame (e.g., the anchor member 1301 can define a W, C, or I-beam type cross-sectional geometry).

The anchor member 1301 can include a proximal anchor end 1303 and a distal anchor end 1304 that is opposite the proximal anchor end 1303. The proximal anchor end 1303 can include frame connection member 1211 that can be configured to couple to the solar module support frame 100. For example, as shown at the example at FIG. 13C, proximal anchor end 1303 of anchor member 1301 of the first reinforcement bar anchor 1300A can be configured to couple proximal anchor end 1303 of anchor member 1301 of the first reinforcement bar anchor 1300A to first A-frame leg 110 and proximal anchor end 1303 of anchor member 1301 of the second reinforcement bar anchor 1300B can be configured to couple proximal anchor end 1303 of anchor member 1301 of the second reinforcement bar anchor 1300B to second A-frame leg 112.

The distal anchor end 1304 of the anchor member 1301 can include one or more reinforcement bar connection members 1311 that each can be configured to couple to a reinforcement bar 1302. For example, the illustrated embodiment includes two reinforcement bars 1302, so the distal anchor end 1304 of the anchor member 1301 can include two reinforcement bar connection members 1311—one reinforcement bar connection member 1311 that is configured to receive and couple to a first reinforcement bar 1311 and another reinforcement bar connection member 1311 that is configured to receive and couple to a second reinforcement bar 1311. When the reinforcement bar anchor 1300 is placed within the ground (e.g., placed within bore 619 beneath ground surface 102), the anchor member 1301 can be configured (e.g., have a length configured) to position the proximal anchor end 1303 above the ground surface 102 (e.g., to facilitate connection to the frame 100 at the proximal anchor end 1303 above the ground surface 102) and to position the distal anchor end 1304 beneath the ground surface 102 (e.g., within the bore 619 or 620).

The one or more reinforcement bars 1302 can each include a proximal bar end 1321 and a distal bar end 1322 that is opposite the proximal bar end 1321. The illustrated example shows each reinforcement bar 1302 as generally of a circular cross-sectional geometry, though other embodiments within the scope of this disclosure can include any of a variety of other cross-sectional geometries for the one or more reinforcement bars 1302, such as rectangular or oval as examples. Also, the illustrated example shows each reinforcement bar 1302 as a single strand member each terminating at, and spaced apart from one another at, the distal end 1322, though other embodiments within the scope of this disclosure can include one or more reinforcement bars 1302 that are each formed from two or more stand members and/or are continuous (e.g., FIG. 13D) as the one or more reinforcement bars 1302 extend within the concrete foundation 1305 from one side of the anchor member 1301 to another side of the anchor member 1301

The proximal bar end 1321 can include an anchor connection member 1313. The anchor connection member 1313 of each reinforcement bar 1302 can be configured to engage with the reinforcement bar connection member 1311 at the distal anchor end 1304 at the anchor member 1301. The illustrated embodiment here shows one example of the anchor connection member 1313 as a hook shaped member, through other examples suitable to engage the reinforcement bar connection member 1311 at the distal anchor end 1304 at the anchor member 1301 are within the scope of this disclosure.

As shown at the example at FIG. 13B, the reinforcement bar anchor 1300 can be included at concrete foundation 1305. In particular, the proximal anchor end 1303 can be outside (e.g., above) the concrete foundation 1305, while the distal anchor end 1304 and each of the one or more reinforcement bars 1302 can be within the concrete foundation 1305 (e.g., and beneath the ground surface 102). The presence of the one or more reinforcement bars 1302 coupled to the anchor member 1301 and within the concrete foundation 1305 can help to increase the load bearing capacity associated with the concrete foundation 1305 while yet also reducing the amount of material, and thus cost, needed within the concrete foundation 1305 to provide this increased load bearing capacity.

A method of installing a concrete foundation can be executed to embed the concrete foundation 1305 in the ground with the reinforcement bar anchor 1300. As one such embodiment, a first step can include creating a bore 619 under the ground surface 102 and/or creating a second bore 620 under the ground surface 102 and spaced apart along the ground surface 102 from the first bore 619. Then, as a next step, each of distal end 1304 of first anchor member 1301A, first reinforcement bar 1302A received at the distal end 1304 of the first anchor member 1301A, and second reinforcement bar 1302 received at the distal end 1304 of the first anchor member 1301A can be placed within first bore 619 beneath ground surface 102. This step can also include placing cement within the first bore 619 beneath the ground surface 102 before, after, or simultaneous to placing the distal end 1304 of the first anchor member 1301A within the first bore 619. Likewise, each of distal end 1304 of second anchor member 1301B, third reinforcement bar 1302B received at the distal end 1304 of the second anchor member 1301B, and fourth reinforcement bar 1302B received at the distal end 1304 of the second anchor member 1301B can be placed within the second bore 620 beneath the ground surface 102. This step can also include placing cement within the second bore 620 beneath the ground surface 102 before, after, or simultaneous to placing the distal end 1304 of the second anchor member 1301B within the first bore 619. This method can additionally include steps of: coupling first leg 110 of a solar module A-frame support 100 to a first frame connection member 1211 at a proximal end 1303 of the first anchor member 1301A that is above the ground surface 102; and coupling second leg 112 of the solar module A-frame support 100 to a second frame connection member 1211 at proximal end 1303 of the second anchor member 1301B that is above the ground surface 102.

FIG. 13D is a perspective view of the reinforcement bar anchor 1300 for a concrete foundation but in this example the reinforcement bar anchor 1300 includes a continuous reinforcement bar 1352 at concrete foundation 1305. The example of the reinforcement bar anchor 1300 shown at FIG. 13D can be similar to, or the same as, that described previously herein with respect to FIGS. 13A-13C except that the reinforcement bar anchor 1300 shown at FIG. 13D includes continuous reinforcement bar 1352 instead of separate reinforcement bars 1302 as illustrated for the example at FIGS. 13A-13C.

For this embodiment, the reinforcement bar anchor 1301 can include the anchor member 1301 and the continuous reinforcement bar 1352. The continuous reinforcement bar 1352 can extend continuously from a first proximal bar end 1321A at one end to a second proximal bar end 1321B at another opposite end of the continuous reinforcement bar 1352. The first proximal bar end 1321A can include one anchor connection member 1313 and the second proximal bar end 1321B can include another anchor connection member 1313. The first proximal bar end 1321A can be at the anchor member 1301 and the second proximal bar end 1321B can be at the anchor member 1301. For example, the anchor connection member 1313 at the first proximal bar end 1321A can engage to the anchor member 1301 at a first reinforcement bar connection member 1311 (e.g., at a first side of the anchor member 1301) and the anchor connection member 1313 at the second proximal bar end 1321B can engage to the anchor member 1301 at a second reinforcement bar connection member 1311 (e.g., at a second, opposite side of the anchor member 1301). Because the continuous reinforcement bar 1352 can extend continuously from the first proximal bar end 1321A to the second proximal bar end 1321B, distal end 1322 of continuous reinforcement bar 1352 can bridge between the portion of the continuous reinforcement bar 1352 extending from the first proximal bar end 1321A and the portion of the continuous reinforcement bar 1352 extending from the second proximal bar end 1321B.

As shown for the illustrated embodiment at FIG. 13D, the reinforcement bar anchor 1300 can be included at concrete foundation 1305. In particular, the proximal anchor end 1303 can be outside (e.g., above) the concrete foundation 1305, while the distal anchor end 1304 and the continuous reinforcement bar 1352 can be within the concrete foundation 1305 (e.g., and beneath the ground surface). The presence of the continuous reinforcement bar 1352 coupled to the anchor member 1301 and within the concrete foundation 1305 can help to increase the load bearing capacity associated with the concrete foundation 1305 while yet also reducing the amount of material, and thus cost, needed within the concrete foundation 1305 to provide this increased load bearing capacity (e.g., because the continuous reinforcement bar 1352 can require relatively less material to provide this increased load bearing capacity associated with the concrete foundation 1305).

A method of installing a concrete foundation can be executed to embed the concrete foundation 1305 in the ground with the reinforcement bar anchor 1300 having the continuous reinforcement bar 1352. As one such embodiment, a first step can include creating a bore under the ground surface. Then, as a next step, each of distal end 1304 of anchor member 1301 and continuous reinforcement bar 1352, received at the distal end 1304 of the anchor member 1301, can be placed within the bore beneath ground surface. This step can also include placing cement within the bore beneath the ground surface before, after, or simultaneous to placing the distal end 1304 of the anchor member 1301 within the bore. This method can additionally include steps of coupling a leg of a solar module support to first frame connection member 1211 at a proximal end 1303 of the anchor member 1301A that is above the ground surface.

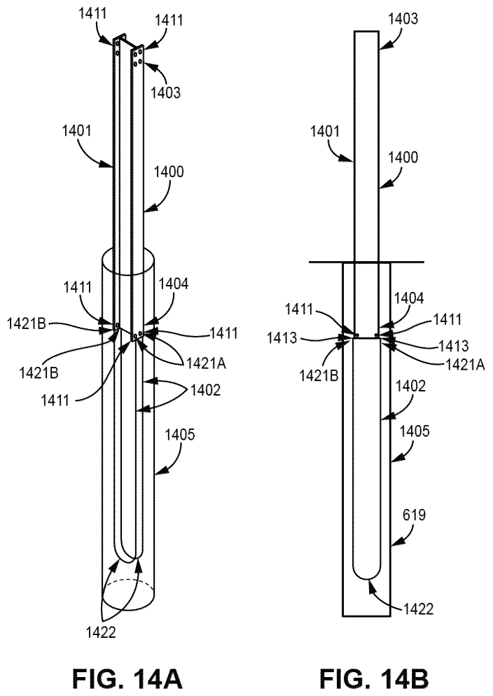

FIGS. 14A and 14B illustrate another embodiment of a reinforcement bar anchor 1400 at a concrete foundation 1405. FIG. 14A is a perspective view of the reinforcement bar anchor 1400 at the concrete foundation 1405, and FIG. 14B is a side elevational view of the reinforcement bar anchor 1400 at the concrete foundation 1405.

The reinforcement bar anchor 1400 can include anchor member 1401 and one or more reinforcement bars 1402. The illustrated embodiment shows that the reinforcement bar anchor 1400 can include two reinforcement bars 1402 (e.g., seen at the view at FIG. 14A) spaced apart from one another, though for other embodiments within the scope of this disclosure the reinforcement bar anchor 1400 can include other numbers of reinforcement bars 1402, such as one reinforcement bar 1402 or more than two reinforcement bars 1402 (e.g., each spaced apart from one another). And the illustrated embodiment shows that the reinforcement bar anchor 1400 includes the two reinforcement bars 1402 that each can be a single strand continuous reinforcement member, though other embodiments within the scope of this disclosure can include one or more reinforcement bars 1402 that are each formed from two or more strand continuous strand members and/or are multiple strand members each terminating at a distal end to be spaced apart from one another within the concrete foundation 1405.

The anchor member 1401 can be configured to receive the reinforcement bar(s) 1402 to assemble the reinforcement bar anchor 1400. The anchor member 1401 is illustrated for the exemplary embodiment here as a W-beam, though in other embodiments the anchor member 1401 can have other cross-sectional geometries such as a generally cylindrical hollow section, rectangular hollow section, square hollow section, C-beam section, or I-beam section as examples. For some applications, the anchor member 1401 can serve as a foundation support pile embedded at least partially within the ground surface. For some applications, the anchor member 1401 can serve both as a foundation support pile embedded at least partially within the ground surface and itself as a leg of a solar module support frame (e.g., a single leg W-beam solar module support frame defined by the W-beam anchor member 1401 embedded at a distal end within the ground and extend above ground at an opposite proximal end where one or more solar tracker components can be installed, such as a bearing housing assembly or a drive mechanism for the solar tracker system).

The anchor member 1401 can include a proximal anchor end 1403 and a distal anchor end 1404 that is opposite the proximal anchor end 1403. The proximal anchor end 1403 can include one or more connection members 1411 that can be configured to couple to one or more solar tracker system components. For example, anchor end 1403 of anchor member 1401 can be configured to couple proximal anchor end 1403 of anchor member 1401 to a bearing housing assembly, a drive mechanism, a solar module, or other solar tracker system component via the one or more connection members 1411 at the proximal anchor end 1403. As shown for the illustrated embodiment, the proximal anchor end 1403 of the anchor member 1401 can include one or more connection members 1411 at a first side of the proximal anchor end 1403 and one or more connection members 1411 at a second, opposite side of the proximal anchor end 1403 such that the proximal anchor end 1403 can be configured to couple to one or more solar tracker components at both the first and second opposite sides of the proximal anchor end 1403.

The distal anchor end 1404 of the anchor member 1401 can include one or more reinforcement bar connection members 1411 that each can be configured to couple to one or more reinforcement bars 1402. For example, the illustrated embodiment includes two reinforcement bars 1402, so the distal anchor end 1404 of the anchor member 1401 can include two pairs of reinforcement bar connection members 1411—one pair of reinforcement bar connection members 1411 that is configured to receive and couple to one reinforcement bar 1402 and another pair of reinforcement bar connection members 1411 that is configured to receive and couple to another reinforcement bar 1402. When the reinforcement bar anchor 1400 is placed at least partially within the ground (e.g., placed within bore 619 beneath ground surface), the anchor member 1401 can be configured (e.g., have a length configured) to position the proximal anchor end 1403 exposed above the ground surface 102 (e.g., to facilitate connection to one or more solar tracker components at the proximal anchor end 1403 above the ground surface 102) and to position the distal anchor end 1404 beneath the ground surface 102 (e.g., within the bore 619).

The one or more reinforcement bars 1402 can each include a proximal bar end 1421 and a distal bar end 1422 that is opposite the proximal bar end 1421. The illustrated example shows each reinforcement bar 1402 as generally of a circular cross-sectional geometry, though other embodiments within the scope of this disclosure can include any of a variety of other cross-sectional geometries for the one or more reinforcement bars 1402, such as rectangular or oval as examples. Also, the illustrated example shows each reinforcement bar 1402 as a single strand member, though other embodiments within the scope of this disclosure can include one or more reinforcement bars 1402 that are each formed from two or more stand members within the concrete foundation 1405.

For the illustrated embodiment, the two reinforcement bars 1402 are each continuous reinforcement bars, such as described previously herein with respect to the continuous reinforcement bar 1352 with respect to FIG. 13D. The reinforcement bar anchor 1400 can include the anchor member 1401, here shown as a W-beam, and one or more continuous reinforcement bars 1402. Each continuous reinforcement bar 1402 can extend continuously from a first proximal bar end 1421A at one end to a second proximal bar end 1421B at another opposite end of the continuous reinforcement bar 1402. Each first proximal bar end 1421A can include an anchor connection member 1413 and each second proximal bar end 1421B can include another anchor connection member 1413. Each first proximal bar end 1421A can be at the anchor member 1401 and each second proximal bar end 1421B can be at the anchor member 1401. For example, the anchor connection member 1413 at each first proximal bar end 1421A can engage to the anchor member 1401 at a respective reinforcement bar connection member 1411, which can be at opposite sides of the distal anchor end 1404. Because each continuous reinforcement bar 1402 can extend continuously from the first proximal bar end 1421A to the second proximal bar end 1421B, distal end 1422 of continuous reinforcement bar 1402 can bridge between the portion of the continuous reinforcement bar 1402 extending from the first proximal bar end 1421A and the portion of the continuous reinforcement bar 1402 extending from the second proximal bar end 1421B.

As shown for the illustrated embodiment at FIGS. 14A and 14B, the reinforcement bar anchor 1400 can be included at concrete foundation 1405. In particular, the proximal anchor end 1403 can be outside (e.g., above) the concrete foundation 1405, while the distal anchor end 1404 and the continuous reinforcement bar(s) 1402 can be within the concrete foundation 1405 (e.g., and beneath the ground surface 102). The presence of the continuous reinforcement bar(s) 1402 coupled to the anchor member 1401 and within the concrete foundation 1405 can help to increase the load bearing capacity and/or pull-out force associated with the concrete foundation 1405 while yet also reducing the amount of material, and thus cost, needed within the concrete foundation 1405 to provide this increased load bearing capacity.

A method of installing a concrete foundation can be executed to embed the concrete foundation 1405 in the ground with the reinforcement bar anchor 1400 having one or more continuous reinforcement bars 1402. As one such embodiment, a first step can include creating a bore under the ground surface 102. Then, as a next step, each of distal end 1404 of anchor member 1401 and continuous reinforcement bar(s) 1402, received at the distal end 1404 of the anchor member 1401, can be placed within the bore beneath ground surface. This step can also include placing cement within the bore beneath the ground surface before, after, or simultaneous to placing the distal end 1404 of the anchor member 1401 within the bore. This method can additionally include a step of coupling at least one solar tracker component (e.g., bearing housing assembly, drive mechanism, solar module) to the anchor member 1401 (e.g., W-beam) at proximal end 1403 of the anchor member 1401 that is above the ground surface (e.g., at one or more of the connection members 1411).

Various examples have been described. These and other examples are within the scope of the following claims.

What is claimed is:

1. A solar module support and foundation system comprising:
a first foundation comprising: a first bore extending a depth below a ground surface, and a first concrete foundation within the first bore, the first concrete foundation comprising a first concrete foundation stem portion and a first concrete foundation reamed bulb portion, the first concrete foundation reamed bulb portion having a greater width than the first concrete foundation stem portion;
a second foundation comprising: a second bore extending a depth below the ground surface, and a second concrete foundation within the second bore, the second concrete foundation comprising a second concrete foundation stem portion and a second concrete foundation reamed bulb portion, the second concrete foundation reamed bulb portion having a greater width than the second concrete foundation stem portion; and
a solar module A-frame support comprising:
a first leg having a first leg proximal end and a first leg distal end, the first leg distal end nested within the first concrete foundation at each of the first concrete foundation stem portion and the first concrete foundation reamed bulb portion; and
a second leg having a second leg proximal end and a second leg distal end, the second leg distal end nested within the second concrete foundation at each of the second concrete foundation stem portion and the second concrete foundation reamed bulb portion.

2. The system of claim 1, wherein the first concrete foundation reamed bulb portion is embedded below the ground surface adjacent the ground surface and the first concrete foundation stem portion is embedded below the ground surface below the first concrete foundation bulb portion.

3. The system of claim 2, wherein a width of the first concrete foundation bulb portion is at least twice as large as a width of the first concrete foundation stem portion.

4. The system of claim 2, wherein the second concrete foundation reamed bulb portion is embedded below the ground surface adjacent the ground surface and the second concrete foundation stem portion is embedded below the ground surface below the second concrete foundation bulb portion.

5. The system of claim 1, wherein the first concrete foundation stem portion is embedded below the ground surface adjacent the ground surface and the first concrete foundation bulb portion is embedded below the ground surface below the first concrete foundation stem portion.

6. The system of claim 5, wherein the first concrete foundation stem portion bounds the first concrete foundation bulb portion such that the first concrete foundation stem portion is at each of opposite longitudinal end portions of the first concrete foundation and the first concrete foundation bulb portion is spaced apart from each of the opposite longitudinal end portions of the first concrete foundation.

7. The system of claim 6, wherein the first concrete foundation bulb portion is spaced apart a different distance from each of the opposite longitudinal end portions of the first concrete foundation.

8. The system of claim 7, wherein the first concrete foundation bulb portion is spaced apart from a distal longitudinal end portion of the first concrete foundation a distance equal to at least half of a width of the first concrete foundation stem portion.

9. The system of claim 5, wherein the second concrete foundation stem portion is embedded below the ground surface adjacent the ground surface and the second concrete foundation bulb portion is embedded below the ground surface below the second concrete foundation stem portion.

10. The system of claim 1, wherein the first concrete foundation reamed bulb portion comprises a polygonal cross-sectional shape, and wherein the second concrete foundation reamed bulb portion comprises a polygonal cross-sectional shape.

11. The system of claim 10,
wherein a first radial surface at a first side of the polygonal cross-sectional shape of the first concrete foundation reamed bulb portion comprises a first skewed surface relative to a central longitudinal axis of the first concrete foundation, and
wherein a second radial surface at a second, opposite side of the polygonal cross-sectional shape of the first concrete foundation reamed bulb portion comprises a second skewed surface relative to the central longitudinal axis of the first concrete foundation.

12. The system of claim 1, wherein the solar module A-frame support further comprises: a bracket above the ground surface and adjacent the first leg proximal end and the second leg proximal end.

13. The system of claim 1, wherein each of the first concrete foundation and the second concrete foundation is a pre-cast concrete foundation.

14. The system of claim 1, wherein the solar module A-frame support further comprises a cross-brace extending between the first leg and the second leg above the ground surface.

15. The system of claim 1, wherein the first leg comprises a polygonal cross-sectional shape, and wherein the second leg comprises a polygonal cross-sectional shape.

16. The system of claim 1, wherein the first leg comprises a triangular cross-sectional shape, and wherein the second leg comprises the triangular cross-sectional shape.

17. The system of claim 1, wherein the first leg proximal end is integral with the first leg distal end, wherein the second leg proximal end is integral with the second leg distal end, and wherein the first leg distal end is closed, and wherein the second leg distal end is closed.

18. A method comprising the steps of:
placing a distal end of a first split tube subterranean leg within a first bore beneath a ground surface and placing cement within the first bore beneath the ground surface, wherein the first split tube subterranean leg is placed within the first bore such that a first frame connection member at a proximal end of the first split tube subterranean leg is above the ground surface;
placing a distal end of a second split tube subterranean leg within a second bore beneath the ground surface and placing cement within the second bore beneath the ground surface, wherein the second split tube subterranean leg is placed within the second bore such that a second frame connection member at a proximal end of the second split tube subterranean leg is above the ground surface;
coupling a first leg of a solar module A-frame support to the first frame connection member at the proximal end of the first split tube subterranean leg; and
coupling a second leg of the solar module A-frame support to the second frame connection member at the proximal end of the second split tube subterranean leg.

19. The method of claim 18,
wherein the cement is placed within the first bore before the distal end of the first split tube subterranean leg is placed within the first bore, and wherein the cement is placed within the second bore before the distal end of the second split tube subterranean leg is placed within the first bore, and
wherein the first split tube subterranean leg comprises a split prong configuration that includes a first prong member extending around a first portion of a perimeter of the distal end of the split tube subterranean leg, a second prong member extending around a second portion of the perimeter of the distal end of the split tube subterranean leg, a first gap extending around the perimeter of the distal end of the split tube subterranean leg between the first prong member and the second prong member, and a second gap opposite the first gap and extending around the perimeter of the distal end of the split tube subterranean leg between the first prong member and the second prong member.

20. A method comprising the steps of:
placing a distal end of a first anchor member, a first reinforcement bar received at the distal end of the first anchor member, and a second reinforcement bar received at the distal end of the first anchor member within a first bore beneath a ground surface and placing cement within the first bore beneath the ground surface;
placing a distal end of a second anchor member, a third reinforcement bar received at the distal end of the second anchor member, and a fourth reinforcement bar received at the distal end of the second anchor member within a second bore beneath the ground surface and placing cement within the first bore beneath the ground surface;
coupling a first leg of a solar module A-frame support to a first frame connection member at a proximal end of the first anchor member that is above the ground surface; and
coupling a second leg of the solar module A-frame support to a second frame connection member at a proximal end of the second anchor member that is above the ground surface.
